(19) United States
(12) Patent Application Publication
(10) Pub. No.: US 2011/0109760 A1
(43) Pub. Date: May 12, 2011

(54) ELECTRONIC CAMERA

(75) Inventor: Masayoshi Okamoto, Daito-shi (JP)

(73) Assignee: SANYO ELECTRIC CO., LTD., Osaka (JP)

(21) Appl. No.: 12/913,128

(22) Filed: Oct. 27, 2010

(30) Foreign Application Priority Data
Nov. 6, 2009 (JP) 2009-254595

(51) Int. Cl. H04N 5/228

(52) U.S. Cl. 348/222.1; 348/E05.031

(57) ABSTRACT

An electronic camera includes an imager. An imager, having an imaging surface capturing a scene, repeatedly generates a scene image. A first searcher searches for a partial image having a specific pattern from the scene image generated by the imager. An adjuster adjusts an imaging condition by noticing an object which is equivalent to the partial image discovered by the first searcher. A second searcher searches for the partial image having the specific pattern from the scene image generated by the imager after an adjusting process of the adjuster is completed. A first recorder records the scene image corresponding to the partial image discovered by the second searcher out of the scene image generated by the imager.

### CROSS REFERENCE OF RELATED APPLICATION

The disclosure of Japanese Patent Application No. 2009-254595, which was filed on Nov. 6, 2009, is incorporated herein by reference.

### BACKGROUND OF THE INVENTION

1. Field of the Invention

The present invention relates to an electronic camera. More particularly, the present invention relates to an electronic camera which searches for a specific object image from a scene image.

2. Description of the Related Art

According to one example of this type of apparatus, a scene image is repeatedly outputted from an image sensor. A CPU repeatedly determines, prior to a half-depression of a shutter button, whether or not a face image facing an imaging surface is appeared on the scene image outputted from the image sensor. A detection history of the face including a determined result is described in a face-detecting history table by the CPU. When the shutter button is half depressed, the CPU determines a face image position based on the detection history of the face described in the face-detecting history table. An imaging condition such as focus is adjusted by noticing the determined face image position. Thereby, it becomes possible to appropriately adjust the imaging condition by noticing the face image.

However, in the above-described apparatus, a face appeared in a recorded image is not always directed to the front, and therefore, an imaging performance is limited in this regard.

### SUMMARY OF THE INVENTION

An electronic camera according to the present invention, comprises: an imager, having an imaging surface capturing a scene, which repeatedly generates a scene image; a first searcher which searches for a partial image having a specific pattern from the scene image generated by the imager; an adjuster which adjusts an imaging condition by noticing an object which is equivalent to the partial image discovered by the first searcher; a second searcher which searches for the partial image having the specific pattern from the scene image generated by the imager after an adjusting process of the adjuster is completed; and a first recorder which records the scene image corresponding to the partial image discovered by the second searcher out of the scene image generated by the imager.

An imaging control program product according to the present invention is an imaging control program product executed by a processor of the electronic camera provided with the imager, having the imaging surface capturing the scene, which repeatedly generates the scene image, comprises: a first searching step which searches for the partial image having the specific pattern from the scene image generated by the imager; an adjusting step which adjusts the imaging condition by noticing the object which is equivalent to the partial image discovered by the first searching step; a second searching step which searches for the partial image having the specific pattern from the scene image generated by the imager after the adjusting process of the adjusting step is completed; and a recording step which records the scene image corresponding to the partial image discovered by the second searching step out of the scene image generated by the imager.

An imaging control method according to the present invention is an imaging control method executed by the electronic camera provided with the imager, having the imaging surface capturing the scene, which repeatedly generates the scene image, comprises: a first searching step which searches for the partial image having the specific pattern from the scene image generated by the imager; an adjusting step which adjusts the imaging condition by noticing the object which is equivalent to the partial image discovered by the first searching step; a second searching step which searches for the partial image having the specific pattern from the scene image generated by the imager after the adjusting process of the adjusting step is completed; and a recording step which records the scene image corresponding to the partial image discovered by the second searching step out of the scene image generated by the imager.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a state where an evaluation area is allocated to an imaging surface;

FIG. 4(A) is an illustrative view showing one example of a face pattern contained in a dictionary DC_1;

FIG. 4(B) is an illustrative view showing one example of the face pattern contained in a dictionary DC_2;

FIG. 4(C) is an illustrative view showing one example of the face pattern contained in a dictionary DC_3;

FIG. 5 is an illustrative view showing one example of a register referred to in a whole area searching process;

FIG. 6 is an illustrative view showing one example of a face-detection frame structure used for the whole area searching process;

FIG. 7 is an illustrative view showing one example of the whole area searching process;

FIG. 8 is an illustrative view showing one example of an image representing an animal captured by the imaging surface;

FIG. 9 is an illustrative view showing one portion of a limited searching process;

FIG. 10 is an illustrative view showing one example of the face-detection frame structure used for the limited searching process;

FIG. 11 is an illustrative view showing another example of the image representing the animal captured by the imaging surface;

FIG. 12 is a timing chart showing one example of imaging behavior;

FIG. 13 is a timing chart showing another example of the imaging behavior;

FIG. 14 is a timing chart showing still another example of the imaging behavior;

FIG. 15 is a flowchart showing one portion of behavior of a CPU applied to the embodiment in FIG. 2;

FIG. 16 is a flowchart showing another portion of behavior of the CPU applied to the embodiment in FIG. 2;

FIG. 17 is a flowchart showing still another portion of behavior of the CPU applied to the embodiment in FIG. 2;

FIG. 18 is a flowchart showing yet another portion of behavior of the CPU applied to the embodiment in FIG. 2;

FIG. 19 is a flowchart showing another portion of behavior of the CPU applied to the embodiment in FIG. 2;

FIG. 20 is a flowchart showing still another portion of behavior of the CPU applied to the embodiment in FIG. 2;

FIG. 21 is a flowchart showing one portion of behavior of the CPU applied to another embodiment;

FIG. 22 is a flowchart showing one portion of behavior of the CPU applied to still another embodiment; and

FIG. 23 is a flowchart showing one portion of behavior of the CPU applied to yet another embodiment.

### DETAILED DESCRIPTION OF THE PREFERRED EMBODIMENTS

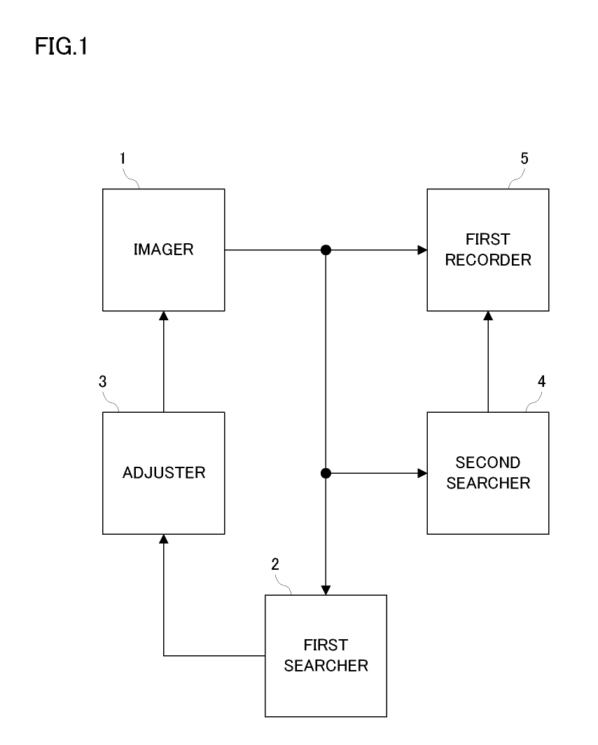

With reference to FIG. 1, an image processing apparatus of one embodiment of the present invention is basically configured as follows: An imager 1, having an imaging surface capturing a scene, repeatedly generates a scene image. A first searcher 2 searches for a partial image having a specific pattern from the scene image generated by the imager 1. An adjuster 3 adjusts an imaging condition by noticing an object which is equivalent to the partial image discovered by the first searcher 2. A second searcher 4 searches for the partial image having the specific pattern from the scene image generated by the imager 1 after an adjusting process of the adjuster 3 is completed. A first recorder 5 records the scene image corresponding to the partial image discovered by the second searcher 4 out of the scene image generated by the imager 1.

The imaging condition is adjusted by noticing the object which is equivalent to a specific object image. Moreover, a searching process of the specific object image is executed again after adjusting the imaging condition. Furthermore, the scene image is recorded corresponding to a discovery of the specific object image by the searching process executed again. Thereby, a frequency of the specific object image appearing on a recorded scene image and an image quality of the specific object image appeared on the recorded scene image are improved. Thus, an imaging performance is improved.

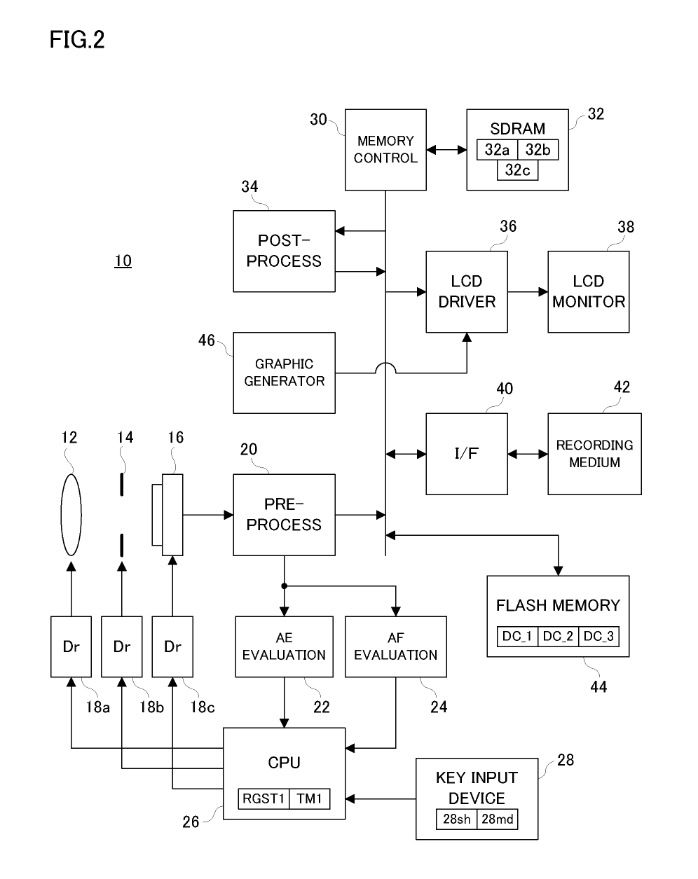

With reference to FIG. 2, a digital camera 10 according to this embodiment includes a focus lens 12 and an aperture unit 14 respectively driven by drivers 18a and 18b. An optical image of the scene that undergoes these components enters, with irradiation, the imaging surface of an imager 16, and is subjected to a photoelectric conversion. Thereby, electric charges representing the scene image are produced.

When a normal imaging mode or a pet imaging mode is selected by a mode key 28md arranged in a key input device 28, a CPU 26 commands a driver 18c to repeat exposure behavior and electric-charge reading-out behavior in order to start a moving-image fetching process under the normal imaging task or the pet imaging task. In response to a vertical synchronization signal Vsync periodically generated from an SG (Signal Generator) not shown, the driver 18c exposes the imaging surface and reads out the electric charges produced on the imaging surface in a raster scanning manner. From the imager 16, raw image data that is based on the read-out electric charges is cyclically outputted.

A pre-processing circuit 20 performs processes, such as digital clamp, pixel defect correction, gain control and etc., on the raw image data outputted from the imager 16. The raw image data on which these processes are performed is written into a raw image area 32a of an SDRAM 32 through a memory control circuit 30.

A post-processing circuit 34 reads out the raw image data accommodated in the raw image area 32a through the memory control circuit 30, performs processes such as a color separation process, a white balance adjusting process, a YUV converting process and etc., on the read-out raw image data, and individually creates display image data and search image data that comply with a YUV format.

The display image data is written into a display image area 32b of the SDRAM 32 by the memory control circuit 30. The search image data is written into a search image area 32c of the SDRAM 32 by the memory control circuit 30.

An LCD driver 36 repeatedly reads out the display image data accommodated in the display image area 32b through the memory control circuit 30, and drives an LCD monitor 38 based on the read-out image data. As a result, a real-time moving image (through image) of the scene is displayed on a monitor screen. It is noted that a process on the search image data will be described later.

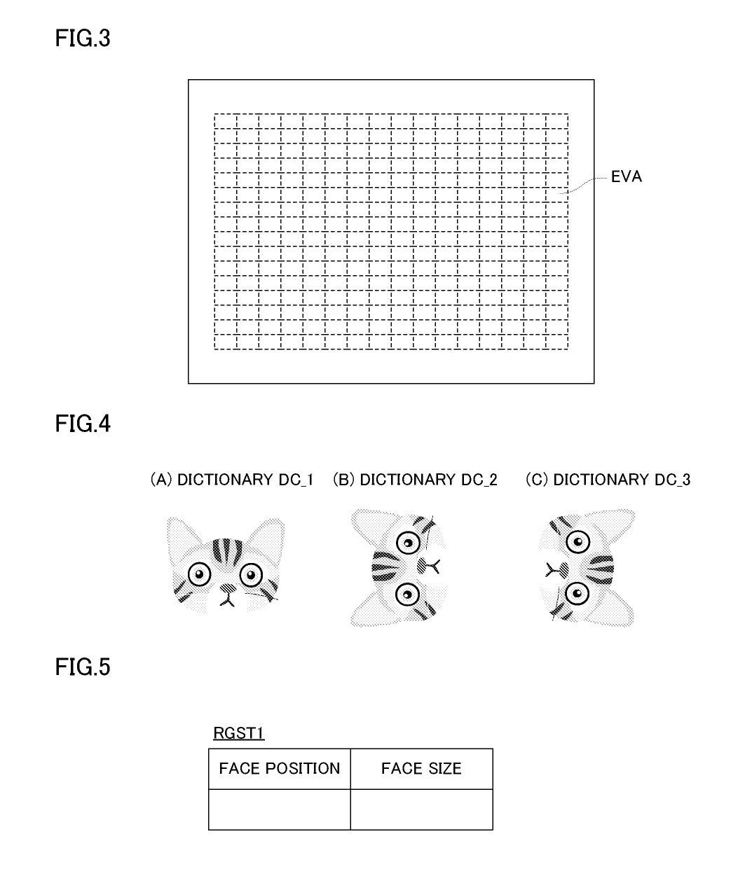

With reference to FIG. 3, an evaluation area EVA is allocated to a center of the imaging surface. The evaluation area EVA is divided into 16 portions in each of a horizontal direction and a vertical direction; therefore, 256 divided areas form the evaluation area EVA. Moreover, in addition to the above-described processes, the pre-processing circuit 20 executes a simple RGB converting process for simply converting the raw image data into RGB data.

An AE evaluating circuit 22 integrates RGB data belonging to the evaluation area EVA, out of the RGB data produced by the pre-processing circuit 20, at each generation of the vertical synchronization signal Vsync. Thereby, 256 integral values, i.e., 256 AE evaluation values, are outputted from the AE evaluating circuit 22 in response to the vertical synchronization signal Vsync.

Moreover, an AF evaluating circuit 24 extracts a high-frequency component of G data belonging to the same evaluation area EVA, out of the RGB data outputted from the pre-processing circuit 20, and integrates the extracted high-frequency component at each generation of the vertical synchronization signal Vsync. Thereby, 256 integral values, i.e., 256 AF evaluation values, are outputted from the AF evaluating circuit 24 in response to the vertical synchronization signal Vsync.

The CPU 26 executes a simple AE process that is based on the output from the AE evaluating circuit 22, in parallel with a moving-image fetching process, so as to calculate an appropriate EV value. An aperture amount and an exposure time period that define the calculated appropriate EV value are set to the drivers 18b and 18c, respectively. As a result, a brightness of the through image is adjusted moderately.

When a shutter button 28sh is half-depressed in a state where the normal imaging mode is selected, the CPU 26 executes an AE process that is based on the output of the AE evaluating circuit 22 under the normal imaging task and respectively sets the aperture amount and the exposure time period that define an optimal EV value calculated thereby to the drivers 18b and 18c. As a result, the brightness of the through image is adjusted strictly. Moreover, the CPU 26 executes an AF process that is based on the output from the AF evaluating circuit 24 under the normal imaging task so as to set the focus lens 12 to a focal point through the driver 18a. Thereby, a sharpness of the through image is improved.

When the shutter button 28sh is shifted from a half-depressed state to a fully-depressed state, the CPU 26 starts up an I/F 40, for a recording process, under the normal imaging task. The I/F 40 reads out one frame of the display image data representing the scene at a time point at which the shutter button 28sh is fully depressed, from the display image area 32b through the memory control circuit 30, and records an image file in which the read-out display image data is contained onto a recording medium 42.

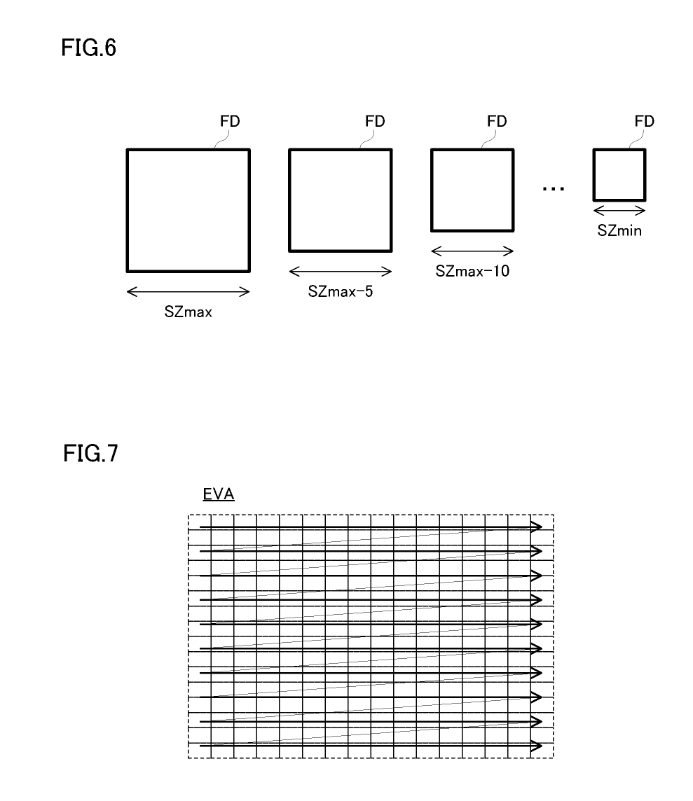

In a case where the pet imaging mode is selected, under a face detecting task executed in parallel with the pet imaging task, the CPU 26 searches for a face image of an animal from the image data accommodated in the search image area 32c. For such a face detecting task, dictionaries DC_1 to DC_3 shown in FIG. 4(A) to (C), a register RGST1 shown in FIG. 5, and a plurality of face-detection frame structures FD, FD, FD, . . . shown in FIG. 6 are prepared.

According to FIG. 4(A) to (C), common face patterns of a cat are contained in the dictionaries DC_1 to DC_3. Herein, the face pattern contained in the dictionary DC_1 corresponds to an upright posture, the face pattern contained in the dictionary DC_2 corresponds to the posture inclined by 90 degrees to a left, and the face pattern contained in the dictionary DC_3 corresponds to the posture inclined by 90 degrees to a right.

The register RGST1 shown in FIG. 5 is equivalent to a register used for holding a face-image information, and is formed by a column in which a position of the detected face image (a position of the face-detection frame structure FD at a time point at which the face image is detected) is described and a column in which a size of the detected face image (a size of the face-detection frame structure FD at a time point at which the face image is detected) is described.

The face-detection frame structure FD shown in FIG. 6 moves in a raster scanning manner on a search area allocated to the search image area 32c, at each generation of the vertical synchronization signal Vsync. The size of the face-detection frame structure FD is reduced by a scale of “5” from a maximum size SZmax to a minimum size SZmin at each time the raster scanning is ended.

Firstly, the search area is set so as to cover the whole evaluation area EVA. Moreover, the maximum size SZmax is set to “200”, and the minimum size SZmin is set to “20”. Therefore, the face-detection frame structure FD, having the size which changes in ranges “200” to “20”, is scanned on the evaluation area EVA as shown in FIG. 7. Below, a face searching process accompanied with the scan shown in FIG. 7 is defined as “whole area searching process”.

The CPU 26 reads out the image data belonging to the face-detection frame structure FD from the search image area 32c through the memory control circuit 30 so as to calculate a characteristic amount of the read-out image data. The calculated characteristic amount is checked with the characteristic amount of the face pattern contained in each of the dictionaries DC_1 to DC_3.

On the assumption that the face of the cat stands upright, a checking degree corresponding to the characteristic amount of the face pattern contained in the dictionary DC_1 exceeds a reference REF when the face of the cat is captured in a posture of a camera housing standing upright. Moreover, the checking degree corresponding to the characteristic amount of the face pattern contained in the dictionary DC_2 exceeds the reference REF when the face of the cat is captured in a posture of a camera housing being inclined by 90 degrees to the right. Furthermore, the checking degree corresponding to the characteristic amount of the face pattern contained in the dictionary DC_3 exceeds the reference REF when the face of the cat is captured in a posture of a camera housing being inclined by 90 degrees to the left.

When the checking degree exceeds the reference REF, the CPU 26 regards the face of the cat as being discovered, registers the position and size of the face-detection frame structure FD at a current time point as the face-image information on the register RGST1, and concurrently, issues a face-frame-structure character display command corresponding to the position and size of the face-detection frame structure FD at a current time point toward a graphic generator 46.

The graphic generator 46 creates graphic image data representing a face frame structure, based on an applied face-frame-structure character display command, and applies the created graphic image data to the LCD driver 36. The LCD driver 36 displays a face-frame-structure character KF1 on the LCD monitor 38, based on the applied graphic image data.

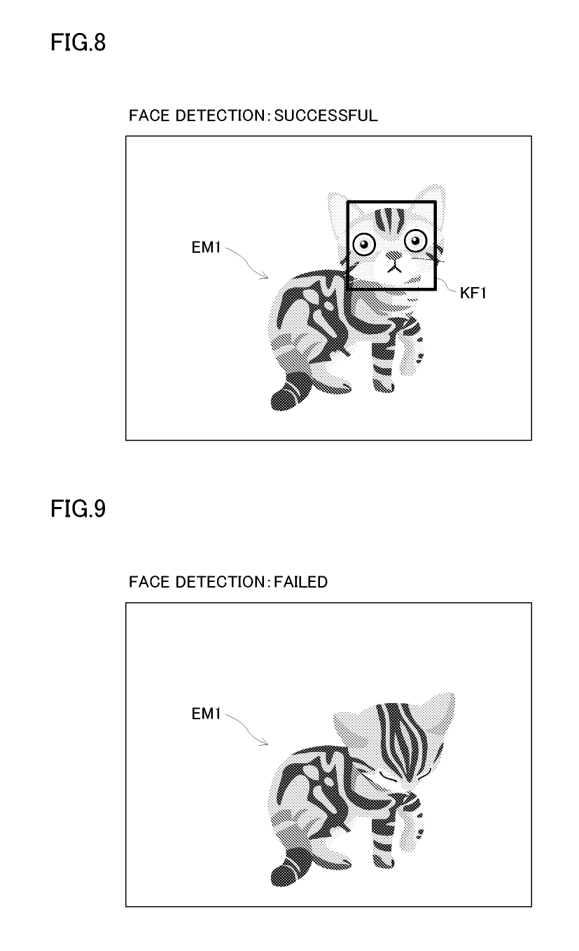

When a cat EM1 shown in FIG. 8 is captured in a posture of the imaging surface standing upright, the checking degree corresponding to the characteristic amount of the face pattern contained in the dictionary DC_1 exceeds the reference REF. The face-frame-structure character KF1 is displayed on the LCD monitor 38 in a manner to surround the face image of the cat EM1.

When the checking degree exceeds the reference REF, under the pet imaging task, the CPU 26 executes the AE process that is based on the output of the AE evaluating circuit 22 and the AF process that is based on the output from the AF evaluating circuit 24. The AE process and the AF process are executed in accordance with the above-described procedure, and therefore, the brightness of the through image is adjusted strictly, and the sharpness of the through image is improved.

However, a time period required for the AE process is fixed while the time period required for the AF process differs depending on the position of the focus lens 12 and/or the cat. Thus, if the time period taken for the AE process is too long, an orientation of the face of the cat may be changed to another orientation as shown in FIG. 9. Considering such an anxiety, the CPU 26 measures the time period taken for the AE process and the AF process under the pet imaging task, and executes a different process depending on a length of the measured-time period, as follows.

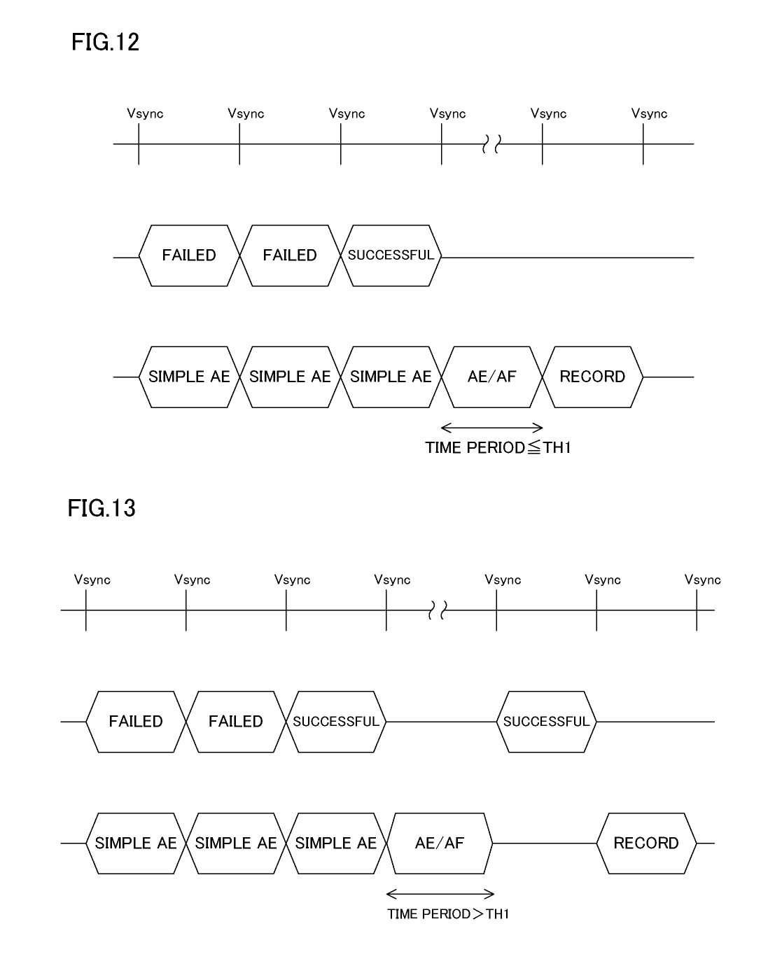

If the measured time period is equal to or less than a threshold value TH1 (=one second for example), the CPU 26 rapidly executes the recording process. The recording process is executed at a timing shown in FIG. 12, and as a result, one frame of the display image data representing the scene at a time point at which the AE process is completed is recorded on the recording medium 42 in a file format.

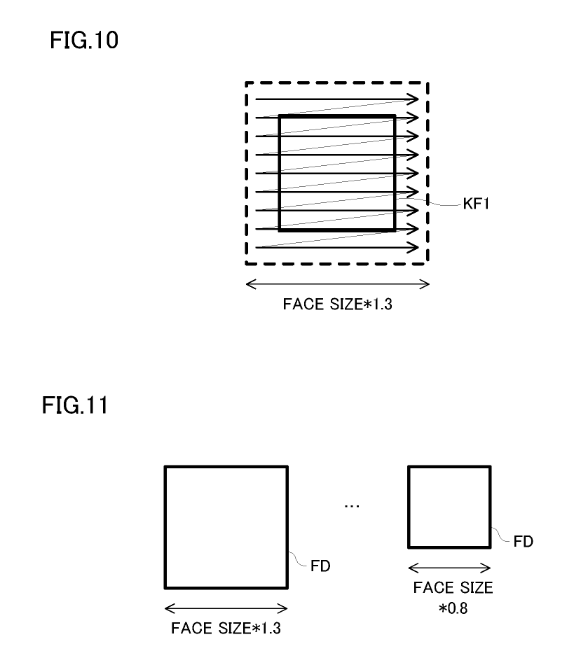

If the measured time period exceeds the threshold value TH1, the CPU 26 searches for the face image of the cat under the face detecting task again. However, the CPU 26 sets a partial area covering the face image registered on the register RGST1 as the search area. As shown in FIG. 10, the search area, having a size which is 1.3 times of the face size registered on the register RGST1, is allocated to a position which is equivalent to the face position registered on the register RGST1. As shown in FIG. 11, the CPU 26 also sets the maximum size SZmax to a value which is 1.3 times of the face size registered on the register RGST1, and sets the minimum size SZmin to a value which is 0.8 times of the face size registered on the register RGST1.

Thus, the face-detection frame structure FD, having the size changes in a partial range defined by the maximum size SZmax and the minimum size SZmin, is scanned as shown in FIG. 10. Below, the face searching process accompanied with the scan shown in FIG. 10 is defined as “limited searching process”.

Similarly to the above-described case, the CPU 26 reads out the image data belonging to the face-detection frame structure FD from the search image area 32c through the memory control circuit 30 so as to calculate the characteristic amount of the read-out image data. However, at a time point at which the limited search process is executed, the posture of the camera housing is specified, and therefore, the calculated characteristic amount is checked with the characteristic amount of the face pattern contained in the dictionary corresponding to the posture of the camera housing out of the dictionaries DC_1 to DC_3.

When the checking degree exceeds the reference REF, the CPU 26 regards the face of the cat as being rediscovered, and issues a face-frame-structure character display command corresponding to the position and size of the face-detection frame structure FD at the current time point toward the graphic generator 46. As a result, a face-frame-structure character KF1 is displayed on the LCD monitor 38.

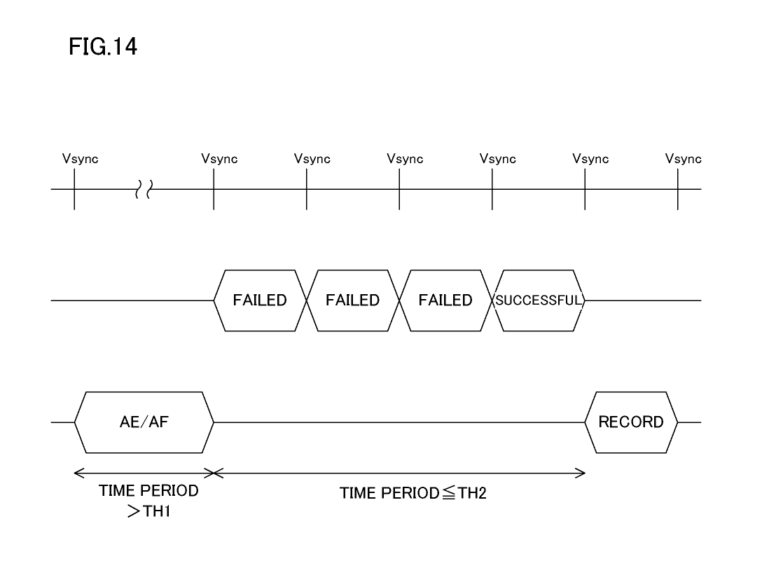

The CPU 26 measures the time period required for the limited search process under the pet imaging task, and compares the measured time period with a threshold value TH2 (three seconds for example). When the checking degree exceeds the reference REF before the measured time period reaches the threshold value TH2, the CPU 26 rapidly executes the recording process. The recording process is executed at a timing shown in FIG. 13 or FIG. 14, and as a result, the image data representing the scene at the time point at which the checking degree exceeds the reference REF is recorded on the recording medium 42 in a file format. On the other hand, when the measured time period reaches the threshold value TH2 without the checking degree exceeding the reference REF, the CPU 26 returns to the above-described whole area search process without executing the recording process.

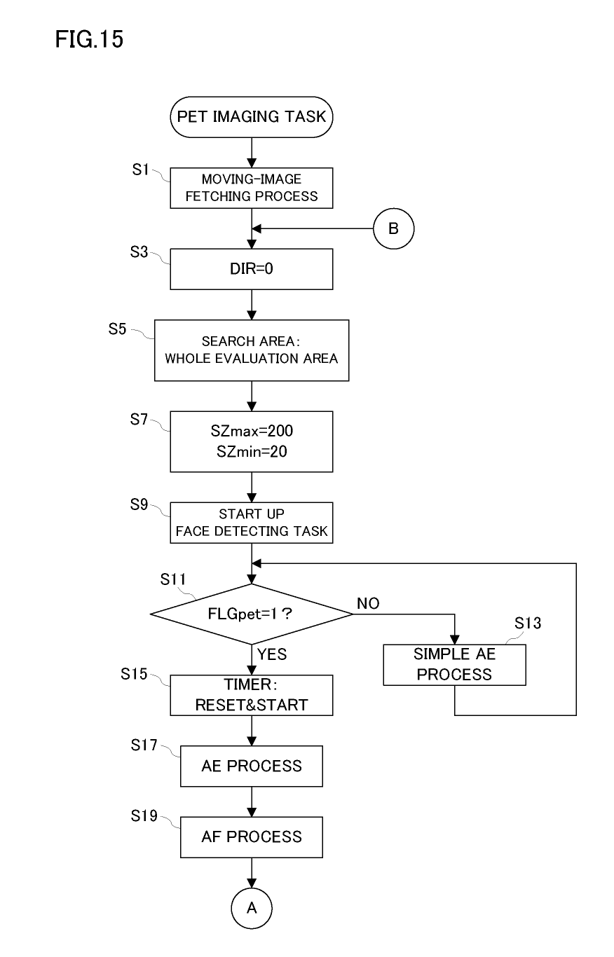

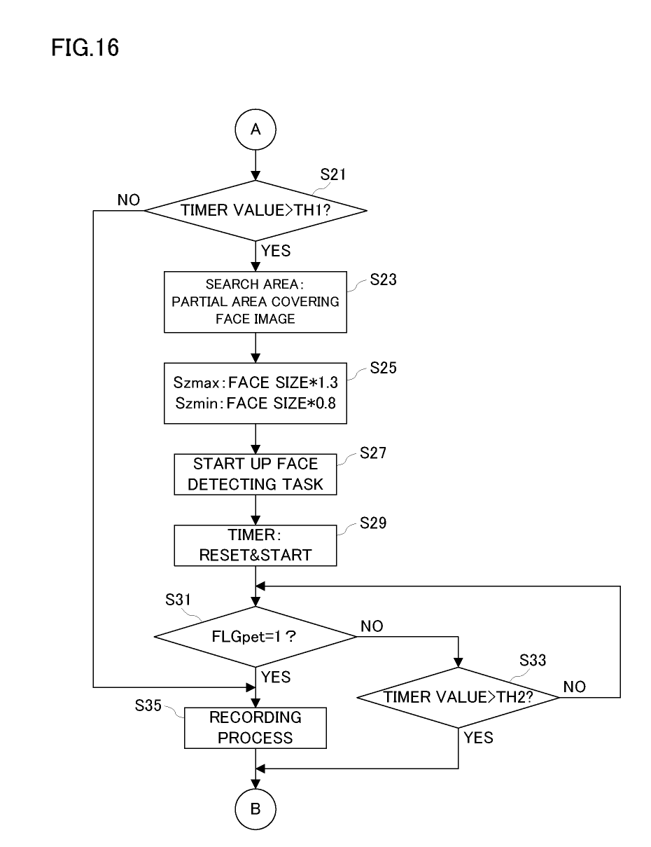

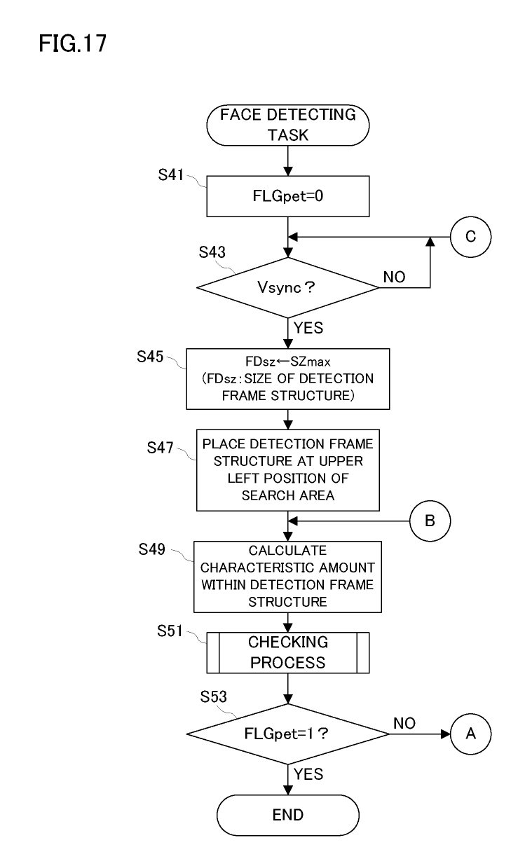

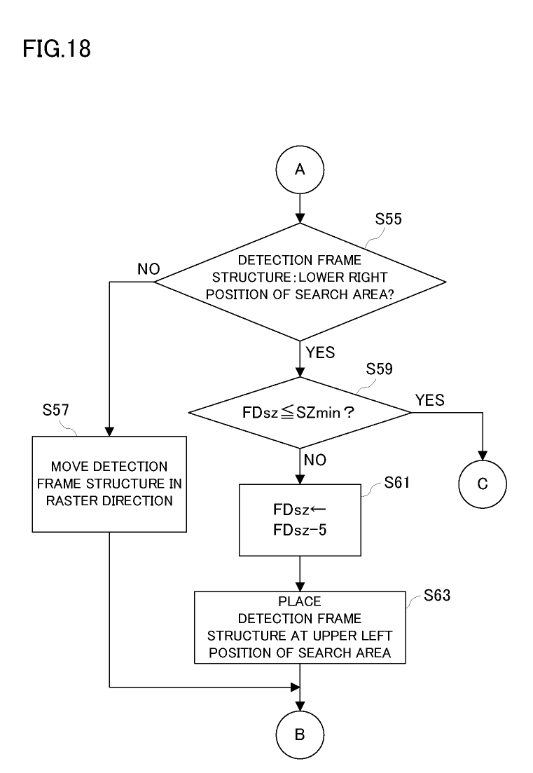

When the pet imaging mode is selected, the CPU 26 executes a plurality of tasks including the pet imaging task shown in FIG. 15 to FIG. 16 and the face detecting task shown in FIG. 17 to FIG. 20, in a parallel manner. A control program product corresponding to these tasks is memorized in a flash memory 44.

With reference to FIG. 15, in a step S1, the moving-image fetching process is executed. As a result, the through image representing the scene is displayed on the LCD monitor 38. In a step S3, a variable DIR is set to “0” in order to declare that the posture of the camera housing is indeterminate. In a step S5, the whole evaluation area EVA is set as the search area. In a step S7, in order to define a variable range of the size of the face-detection frame structure FD, the maximum size SZmax is set to “200”, and the minimum size SZmin is set to “20”. Upon completion of the process in the step S7, the face detecting task is started up in a step S9.

The flag FLGpet is set to “0” as an initial setting under the started-up face detecting task, and is updated to “1” when the face image coincident with any one of the face patterns contained in the dictionaries DC_1 to DC_3 is discovered. In a step S11, it is determined whether or not the flag FLGpet indicates “1”, and as long as a determined result is NO, the simple AE process is repeatedly executed in a step S13. The brightness of the through image is moderately adjusted by the simple AE process.

When the determined result is updated from NO to YES, resetting and starting a timer TM1 is executed in a step S15, and the AE process and the AF process are respectively executed in a step S17 and S19. As a result of the AE process and the AF process, the brightness and the focus of the through image are adjusted strictly.

In a step S21, it is determined whether or not the measured value of the timer TM1 at a time point at which the AF process is completed exceeds the threshold value TH1. When a determined result is NO, the process directly advances to a step S35 and executes the recording process. As a result, the image data representing the scene at a time point at which the AF process is completed is recorded on the recording medium 42 in a file format Upon completion of the recording process, the process returns to the step S3.

When the determined result in the step S21 is YES, the process advances to a step S23, and sets a partial area covering the face image registered on the register RGST1 as the search area. The search area, having the size which is 1.3 times of the face size registered on the register RGST1, is allocated to a position which is equivalent to the face position registered on the register RGST1. In a step S25, the maximum size SZmax is set to the value which is 1.3 times of the face size registered on the register RGST1, and concurrently, the minimum size SZmin is set to the value which is 0.8 times of the face size registered on the register RGST1.

Upon completion of the process in the step S25, the face detecting task is started up again in a step S27, and resetting and starting the timer TM1 is executed in a step S29. As described above, the flag FLGpet is set to “0” as the initial setting under the started-up face detecting task, and is updated to “1” when the face image coincident with any one of the face patterns contained in the dictionaries DC_1 to DC_3 is discovered. In a step S31, it is determined whether or not the flag FLGpet indicates “1”, and in a step S33, it is determined whether or not the measured value of the timer TM1 exceeds the threshold value TH2.

When the flag FLGpet is updated from “0” to “1” before the measured time period of the timer TM1 reaches the threshold value TH2, YES is determined in the step S31, and the recording process is executed in a step S35. As a result, the image data representing the scene at a time point at which the flag FLGpet is updated to “1” is recorded on the recording medium 42 in a file format Upon completion of the recording process, the process returns to the step S3.

When the measured value of the timer TM1 reaches the threshold value TH2 with the flag FLGpet indicating “0”, YES is determined in the step 33, and the process returns to the step S3 without executing the recording process in the step S35.

With reference to FIG. 17, the flag FLGpet is set to “0” in a step S41, and it is determined whether or not the vertical synchronization signal Vsync is generated in a step S43. When a determined result is updated from NO to YES, the size of the face-detection frame structure FD is set to “SZmax” in a step S45, and the face-detection frame structure FD is placed at an upper left position of the search area in a step S47. In a step S49, partial image data belonging to the face-detection frame structure FD is read out from the search image area 32c, and the characteristic amount of the read-out image data is calculated.

In a step S51, a checking process for checking the calculated characteristic amount with the characteristic amount of each of the face patterns contained in the dictionaries DC_1 to DC_3 is executed. Upon completion of the checking process, in a step S53, it is determined whether or not the flag FLGpet indicates “1”. When a determined result is YES, the process is ended while when the determined result is NO, the process advances to a step S55.

In the step S55, it is determined whether or not the face-detection frame structure FD reaches a lower right position of the search area. When a determined result is NO, in a step S57, the face-detection frame structure FD is moved in a raster direction by a predetermined amount, and thereafter, the process returns to the step S49. When the determined result is YES, in a step S59, it is determined whether or not the size of the face-detection frame structure FD is equal to or less than “SZmin”. When the determined result is NO, in a step S61, the size of the face-detection frame structure FD is reduced by “5”, and the face-detection frame structure FD is placed at an upper left position of the search area in a step S63. Thereafter, the process returns to the step S49. When a determined result in the step S59 is YES, the process directly returns to the step S43.

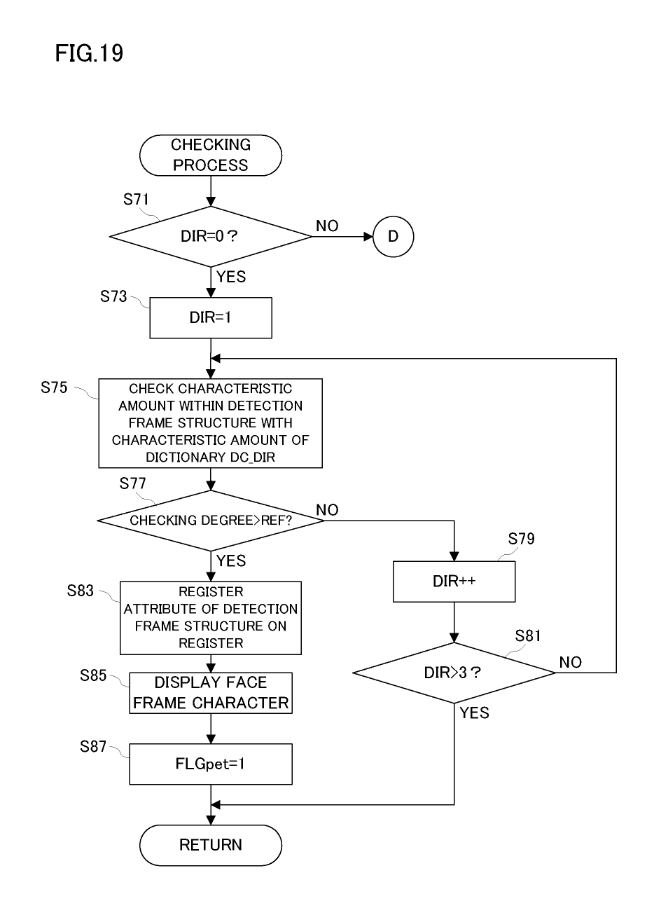

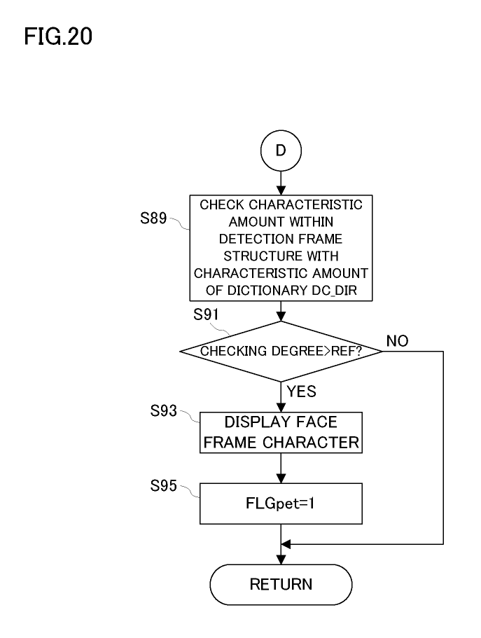

The checking process in the step S51 shown in FIG. 17 is executed according to a subroutine shown in FIG. 19 to FIG. 20. Firstly, in a step S71, it is determined whether or not the variable DIR indicates “0”. When a determined result is YES, the process advances to a step S73 while when the determined result is NO, the process advances to a step S89. Processes from the step S73 onwards are executed corresponding to the whole area searching process, and processes from the step S89 onwards are executed corresponding to the limited searching process.

In the step S73, the variable DIR is set to “1”. In a step S75, the characteristic amount of the image data belonging to the face-detection frame structure FD is checked with the characteristic amount of the face pattern contained in a dictionary DC_DIR. In a step S77, it is determined whether or not the checking degree exceeds the reference REF.

When a determined result is NO, the variable DIR is incremented in a step S79, and in a step S81, it is determined whether or not the incremented variable DIR exceeds “3”. If DIR≦2 is established, the process returns to the step S75 while if DIR>3 is established, the process returns to the routine in an upper hierarchy.

When the determined result in the step S77 is YES, the process advances to a step S83, and the current position and size of the face-detection frame structure FD is registered as the face image information on the register RGST1. In a step S85, the face-frame-structure character display command corresponding to the position and size of the face-detection frame structure FD at the current time point is issued toward the graphic generator 46. As a result, the face-frame-structure character KF1 is displayed on the through image in an OSD manner. Upon completion of the process in a step S85, the flag FLGpet is set to “1” in a step S87, and the process returns to the routine in the upper hierarchy.

In steps S89 to S91, processes similar to that in the above-described steps S75 to S77 are executed. In the step S89, the dictionary corresponding to the posture of the camera housing out of the dictionaries DC_1 to DC_3 is referred. If the checking degree is equal to or less than the reference REF, the process directly returns to the routine in the upper hierarchy, and if the checking degree exceeds the reference REF, in steps S93 to S95, the process executes processes similar to that in the above-described steps S85 to S87, and then returns to the routine in the upper hierarchy.

As can be seen from the above-described explanation, the imager 16, having the imaging surface capturing the scene, repeatedly generates the scene image. The CPU 26 searches for the face image coincident with any one of the face patterns contained in the dictionaries DC_1 to DC_3 from the scene image generated by the imager 16 (S9), and adjusts an imaging parameter by noticing an animal equivalent to the discovered face image (S17, S19). The CPU 26 also searches for the face image coincident with any one of the face patterns contained in the dictionaries DC_1 to DC_3 from the scene image generated by the imager 16 after the adjusting process of the imaging parameter is completed (S27), and records the scene image corresponding to the discovered face image on the recording medium 42 (S31, S35).

Thus, the imaging parameter is adjusted by noticing the animal equivalent to the discovered face image. Moreover, the searching process of the face image is executed again after adjusting the imaging parameter. Furthermore, the scene image is recorded corresponding to the discovery of the face image by the searching process executed again. Thereby, the frequency of the face image of the animal appearing on the recorded scene image and the image quality of the face image of the animal appeared on the recorded scene image are improved. Thus, the imaging performance is improved.

It is noted that in this embodiment, the limited searching process is executed after the AE process and the AF process are completed (see steps S23 to S25 shown in FIG. 16). However, the CPU 26 may optionally execute following processes: the whole area searching process is executed instead of the limited searching process (a single dictionary is referred to, however); it is determined whether or not a predetermined condition is satisfied between the position and/or size of the face image detected by the first whole area searching process and the position and/or size of the face image detected by the second whole area searching process; and the recording process is executed when a determined result is positive while the first whole area searching process is restarted when the determined result is negative.

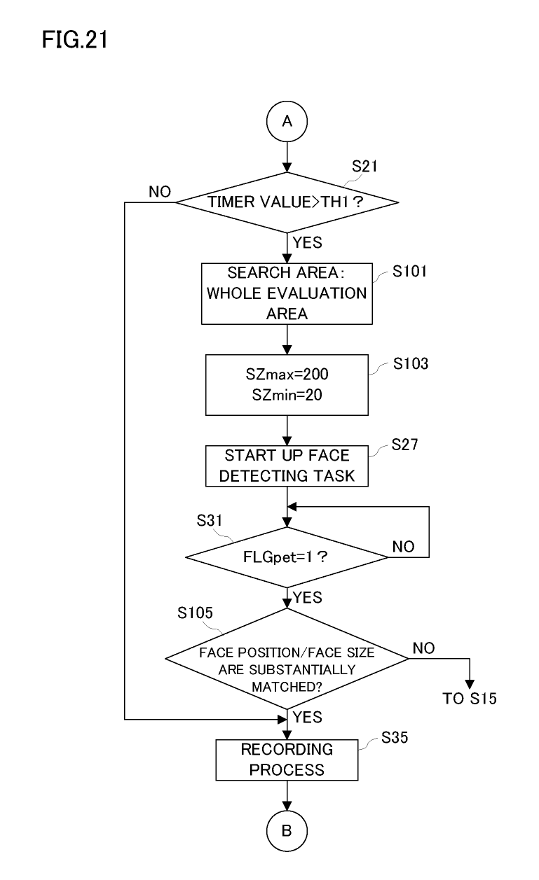

In this case, instead of the process according to the flowchart shown in FIG. 16, the process according to the flowchart shown in FIG. 21 is executed. According to FIG. 21, the processes in the steps S23 to S25 shown in FIG. 16 are alternated by processes in steps S101 to S103. In the steps S101 to S103, processes similar to that in the steps S5 to S7 shown in FIG. 15 are executed.

Moreover, according to FIG. 21, the processes in the steps S31 to S33 shown in FIG. 16 are alternated by a process in a step S105. In a step S105, it is determined whether or not the predetermined condition is satisfied between the position and/or size of the face image detected by the first whole area searching process and the position and/or size of the face image detected by the second whole area searching process. When a determined result is YES, the process advances to the step S35, and when the determined result is NO, the process returns to the step S15.

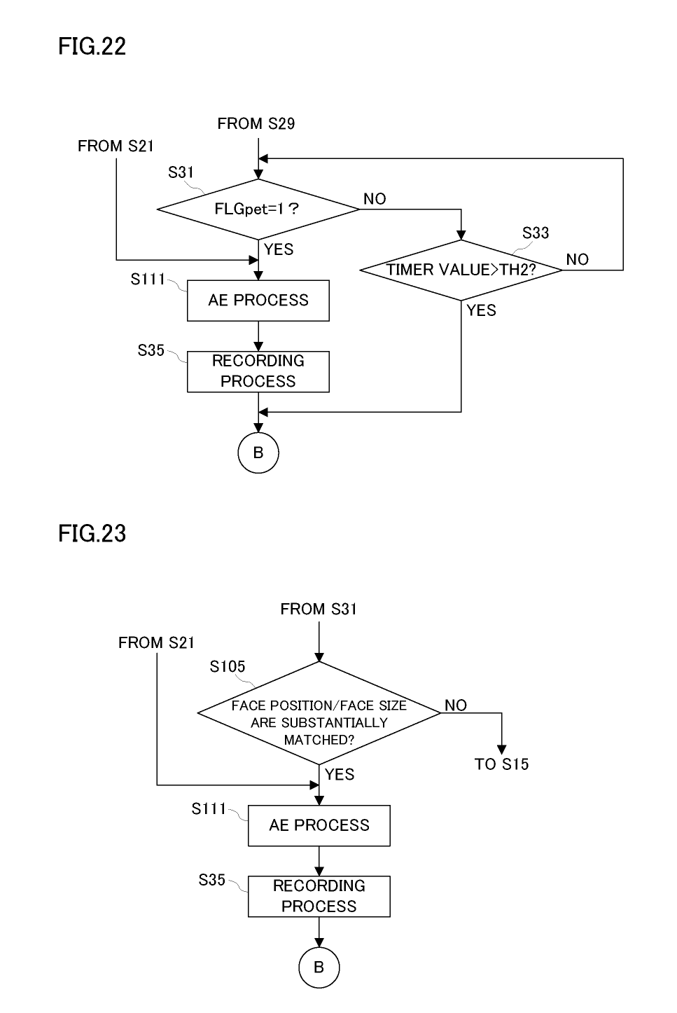

Furthermore, in this embodiment, the imaging condition is adjusted only immediately after the face image is discovered by the whole area searching process (see steps S17 to S19 shown in FIG. 15). However, since the time period required for the AE process is remarkably shorter than the time period required for the AF process, only the AE process may be executed again immediately before the recording process. In this case, as shown in FIG. 22 and FIG. 23, a step S111 which executes the AE process again is added in a preceding step of the step S35 which executes the recording process.

Moreover, in this embodiment, a still camera which records a still image is assumed; however, the present invention is applied to a movie camera which records a moving image.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager, having an imaging surface capturing a scene, which repeatedly generates a scene image;
a first searcher which searches for a partial image having a specific pattern from the scene image generated by said imager;
an adjuster which adjusts an imaging condition by noticing an object which is equivalent to the partial image discovered by said first searcher;
a second searcher which searches for the partial image having the specific pattern from the scene image generated by said imager after an adjusting process of said adjuster is completed; and
a first recorder which records the scene image corresponding to the partial image discovered by said second searcher out of the scene image generated by said imager.

2. An electronic camera according to claim 1, further comprising:
a restrictor which restricts a searching process of said second searcher when a time period taken for the adjusting process of said adjuster is equal to or less than a first threshold value; and
a second recorder which records the scene image generated by said imager corresponding to completion of the adjusting process by said adjuster in association with a restricting process of said restrictor.

3. An electronic camera according to claim 1, further comprising a definer which defines a partial area covering the partial image discovered by said first searcher as a search area of said second searcher.

4. An electronic camera according to claim 3, wherein said first searcher executes the searching process on a larger area than the area defined by said definer.

5. An electronic camera according to claim 3, further comprising a restarter which restarts said first searcher when the time period taken for the searching process of said second searcher exceeds a second threshold value.

6. An electronic camera according to claim 1, further comprising a holder which holds a plurality of specific pattern images respectively corresponding to a plurality of postures, wherein said first searcher includes a first checker which checks the partial image forming the scene image with each of the plurality of specific pattern images held by said holder, and said second searcher includes a second checker which checks the partial image forming the scene image with a part of the plurality of specific pattern images held by said holder.

7. An electronic camera according to claim 6, wherein the part of the specific pattern image noticed by said second checker is equivalent to the specific pattern image which coincides with the partial image discovered by said first searcher.

8. An electronic camera according to claim 6, wherein said first searcher further includes a first size changer which changes a size of the partial image checked by said first checker in a first range, and said second searcher further includes a second size changer which changes the size of the partial image checked by said second checker in a second range narrower than the first range.

9. An electronic camera according to claim 1, further comprising a controller which determines whether or not a predetermined condition is satisfied between a position and/or a size of the partial image discovered by said first searcher and a position and/or a size of the partial image discovered by said second searcher, so as to restart said first searcher corresponding to a negative determined result while start up said first recorder corresponding to a positive determined result.

10. An electronic camera according to claim 1, further comprising an exposure adjuster which adjusts an exposure amount on said imaging surface after the searching process of said second searcher is completed and before a recording process of said first recorder is started.

11. An imaging control program product executed by a processor of an electronic camera provided with an imager, having an imaging surface capturing a scene, which repeatedly generates a scene image, the imaging control program product comprising:
a first searching step which searches for the partial image having the specific pattern from the scene image generated by said imager;
an adjusting step which adjusts the imaging condition by noticing the object which is equivalent to the partial image discovered by the first searching step;
a second searching step which searches for the partial image having the specific pattern from the scene image generated by said imager after the adjusting process of said adjusting step is completed; and
a recording step which records the scene image corresponding to the partial image discovered by the second searching step out of the scene image generated by said imager.

12. An imaging control method executed by an electronic camera provided with an imager, having an imaging surface capturing a scene, which repeatedly generates a scene image, the imaging control method comprises:
a first searching step which searches for the partial image having the specific pattern from the scene image generated by said imager;
an adjusting step which adjusts the imaging condition by noticing the object which is equivalent to the partial image discovered by said first searching step;
a second searching step which searches for the partial image having the specific pattern from the scene image generated by said imager after the adjusting process of said adjusting step is completed; and
a recording step which records the scene image corresponding to the partial image discovered by said second searching step out of the scene image generated by said imager.
